(19) United States
(12) Patent Application Publication
(10) Pub. No.: US 2015/0045986 A1
(43) Pub. Date: Feb. 12, 2015

(54) Systems and Methods for Determining Driver Fatigue Level from Lane Variability and Geographic Location

(71) Applicant: Pulsar Informatics, Inc., Philadelphia, PA (US)

(72) Inventors: Kevin Gar Wah Kan, Philadelphia, PA (US); Christopher Grey Mott, Seattle, WA (US); Daniel Joseph Mollicone, Seattle, WA (US)

(21) Appl. No.: 14/456,951

(22) Filed: Aug. 11, 2014

Related U.S. Application Data
(60) Provisional application No. 61/864,506, filed on Aug. 9, 2013.

(51) Int. Cl. B60W 40/08

(52) U.S. Cl. CPC B60W 40/08; B60W 2040/0872
USPC 701/1

(57) ABSTRACT

Systems and methods are disclosed for determining a fatigue level of a human operator of a motor vehicle based upon lane variability data and geographic position data of the vehicle, used either alone or in combination with other data such as (without limitation) vehicle operational data, vehicle environment data, road segments, and/or the like.

### RELATED APPLICATIONS

This application claims benefit of the priority of U.S. application No. 61/864,506, filed Aug. 9, 2013.

### TECHNICAL FIELD

The presently disclosed invention relates generally to systems, devices, and methods for determining a fatigue level of a human operator of a motor vehicle based upon lane variability data and geographic position data of the vehicle, used either alone or in combination with other data such as (without limitation) vehicle operational data, vehicle environment data, road segments, and/or the like.

### BACKGROUND

Neurobehavioral performance assessment for drivers of vehicles, including without limitation fatigue-level determinations, has been conducted by qualitative and subjective judgment of one or more human agents observing a driver in a particular situation, or using blunt quantitative metrics. Subjective judgments have included collision risk, safety, adherence to road rules and/or the like, and general metrics have included fuel consumption or collision occurrences. Human observation may be expensive and impractical for some applications, and general metrics may not take into account details of the actual driving conditions encountered by the driver. There is a need for systems and methods that determine a fatigue level of a human driver using measured data.

### SUMMARY

Among its many aims and objectives, the presently disclosed invention seeks to ascertain a driver's fatigue level on one or more driving tasks or one or more driving trips using readily available hard data. One particular aspect of the disclosed invention provides a method, using a computer, for determining a fatigue level of a driver of a vehicle based at least upon lane variability data and geographic position data for the vehicle, the method comprising: receiving, at the processor, lane variability data, the lane variability data corresponding to a change of position of a vehicle in a driving lane; receiving, at the processor, geographical position data for the vehicle; identifying, with the processor, a road segment of interest based at least in part on the received geographical data; selecting, with the processor, a subset of the received lane variability data corresponding to the vehicle travelling over the identified road segment of interest; and determining, with the processor, a fatigue level, F, of a driver of the vehicle for the identified road segment of interest based at least in part upon the selected subset of the received lane variability data.

Another particular aspect of the disclosed invention provides a computer program product embodied in a non-transitory medium and comprising computer-readable instructions that when executed by a suitable computer cause the computer to perform a method for determining a fatigue level of a driver of a vehicle based at least in part upon lane variability data and geographic location data for the vehicle, the method comprising: receiving, at the processor, lane variability data, the lane variability data corresponding to a change of position of a vehicle in a driving lane; receiving, at the processor, geographical position data for the vehicle; identifying, with the processor, a road segment of interest based at least in part on the received geographical data; selecting, with the processor, a subset of the received lane variability data corresponding to the vehicle travelling over the identified road segment of interest; and determining, with the processor, a fatigue level, F, of a driver of the vehicle for the identified road segment of interest based at least in part upon the selected subset of the received lane variability data.

### BRIEF DESCRIPTION OF THE DRAWINGS

In the drawings, which depict non-limiting embodiments of the invention:

FIG. 1 comprises a component diagram for an alertness monitoring system 100 for determining a fatigue level of a driver of a vehicle based upon lane variability and geographical location data for the vehicle, according to particular embodiments;

FIG. 2 is a block diagram showing computer system software modules suitable for the alertness monitoring system 100 of FIG. 1, in accordance with particular embodiments;

The multiple views of FIG. 3 provide flowchart diagrams illustrating a method 300 for determining a fatigue level of a driver of a vehicle based upon lane variability and geographical location data for the vehicle, according to particular embodiments, particularly in which:

FIG. 3A provides a flowchart diagram illustrating the overall structure of method 300; and

FIG. 3B provides a flowchart diagrams for optional embodiments of step 305, identifying a road segments, of method 300, according to particular embodiments;

FIG. 4 provides a plot of GPS data (longitude vs. latitude) using a parametric time variable to illustrate how a vehicle path can be analyzed to determine road shape, as used in accordance with particular embodiments; and

FIG. 5 provides a plot of lane position data (distance to right and left lane markers, respectively) to illustrate how lane position data can be analyzed to determine the existence of a lane-change maneuver, as used in accordance with particular embodiments.

### DETAILED DESCRIPTION OF THE INVENTION

Throughout the following discussion, specific details are set forth in order to provide a more thorough understanding of the disclosed invention. The invention, however, may be practiced without these particulars. In other instances, well-known elements have not been shown or described in detail to avoid unnecessarily obscuring the invention. Accordingly, the specification and drawings are to be regarded in an illustrative rather than a restrictive sense.

Embodiments of the invention include features, methods or processes embodied within machine-executable instructions provided by a machine-readable medium. A machine-readable medium includes any mechanism that provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein. As used herein, the term processor means one or more processors, and one or more particular processors, such as a motion detection processor and a motion tracking processor, can be embodied on one or more processors.

One or more figures show block diagrams of systems and apparatus of embodiments of the invention. One or more figures show flow diagrams illustrating systems and apparatus for such embodiments. The operations of the one or more flow diagrams will be described with references to the systems/apparatuses shown in the one or more block diagrams. However, it should be understood that the operations of the one or more flow diagrams could be performed by embodiments of systems and apparatus other than those discussed with reference to the one or more block diagrams, and embodiments discussed with reference to the systems/apparatus could perform operations different than those discussed with reference to the one or more flow diagrams.

The presently disclosed invention relates to alertness monitoring systems and methods used to determine the fatigue level of a driver of a vehicle.

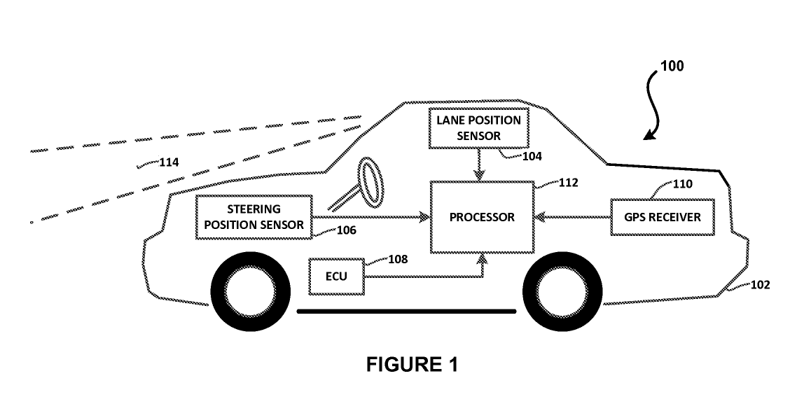

FIG. 1 provides a component-level diagram of alertness monitoring system 100, which illustrates certain hardware components used in particular embodiments of the presently disclosed invention. Alertness monitoring system 100 comprises a vehicle 102, a lane position sensor 104, a steering position sensor 106, an automotive electronic control unit 108, a GPS receiver 110, and a processor 112, and optionally a driver 101 (not shown). Non-limiting examples of vehicle 102 comprise commercial trucks, automobiles, SUVs, pick-up truck, tractor-trailer combinations (singles or doubles), electric cars, sports cars, and/or the like.

According to particular embodiments, steering sensor 106 is configured to measure a steering wheel position of the vehicle 102 and, in non-limiting embodiments, may be installed on an input shaft proximate a gearbox (not shown) or at other suitable locations. In particular embodiments, the steering sensor 106 may include a torque sensing element (not shown) and a rotation sensing element (not shown), used in combination to convert a steering torque input into signals suitable for operation within the remaining elements of system 100, including processor 112. The steering sensor 106 may also include an interface circuit (not shown) configured to convert the signals from the torque and rotation sensing elements into signals corresponding to a steering wheel position or change in steering wheel position of the vehicle 102. In other embodiments, the steering sensor 106 may include only one of the torque and rotation sensing elements, a steering angle sensing element, and/or other suitable sensing elements.

The optional lane position sensor 104 functions to monitor a current lane position, a lane position change, or any combination thereof, of the vehicle 102. According to particular embodiments, lane position sensor 104 comprises at least one magnetic sensing element capable of detecting one or more magnetic markers (not shown) positioned on a roadway or other driving surface. According to particular embodiments, lane position sensor 104 may also comprise a global positioning system (GPS), which in turn comprises, according to particular embodiments, at least a GPS receiver 110 equipped with an electronic map, mapping software, and/or the like capable of locating with a high degree of precision the position of the vehicle 102 on a map. Lane position sensor 104 may also be configured, in particular embodiments, to monitor a lane position of the vehicle 102 based on the current location of the vehicle 102 in relation to the electronic map. In particular embodiments, lane position sensor 104 instead comprises at least a video camera equipped with image processing capabilities or a separate image processing system. The video camera may be configured in particular embodiments to capture a current view of the roadway 114 in front of the vehicle 102, and the image processing capabilities are then used to determine a lane position based on input from the video camera. Other suitable sensing or processing components may be used as are known in the art according to particular embodiments. In yet further embodiments, the lane position sensor 104 may be omitted, and a lane position signal may be derived based on input from the steering sensor 106. In at least one of the foregoing embodiments, the signal acquired by the optional lane position sensor 104 may be processed with a high pass filter to remove low-frequency variability associated with, for example, driving along curves. Such processing may occur at any suitable point along the signal processing chain.

According to particular embodiments system 100 may also comprise an automotive electronic control unit (ECU) 108. The ECU 108 is provided with a CPU (Central Processing Unit), a ROM (Read Only Memory) and a RAM (Random Access Memory), each of which is not illustrated, and it is an electronic control unit capable of controlling all the operations of the vehicle 102. The ECU 108 is one example of the “driving support apparatus of the vehicle” of the present invention. Incidentally, the ECU 108 is a unified or one-body electronic control unit. However, the physical, mechanical and electrical configurations of each of the components of the present invention are not limited to this, and each of the components may be configured as various computer systems, such as a plurality of ECUs, various processing units, various controllers, various microprocessors, or various micro-computer apparatuses.

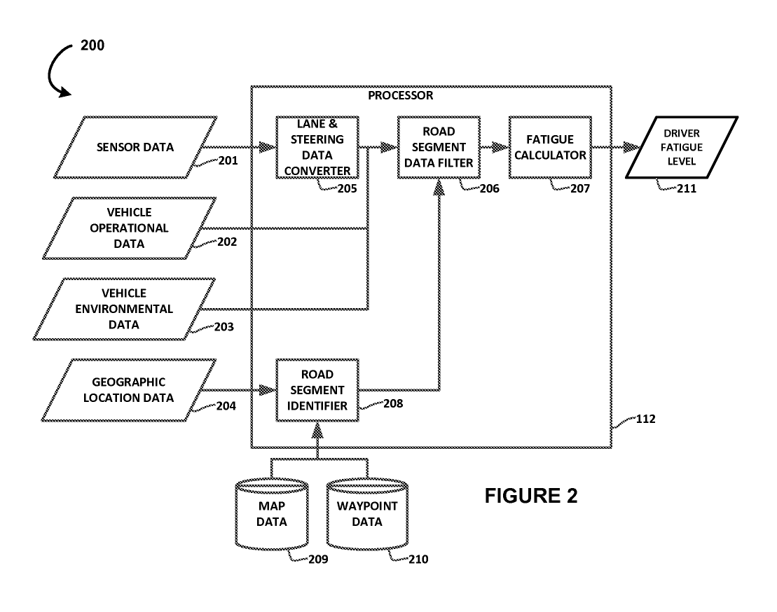

FIG. 2 is a block diagram showing computing system 200 comprising data modules 201 through 204, software modules 205 through 208, and database modules 209 and 210 suitable for the processor 112 of system 100 (see FIG. 1), in accordance with particular embodiments. Each of the data modules 201 through 204 may comprise data input from one or more components of system 100, in accordance with the foregoing discussion. Each software module 205 through 208 may comprise a computer program, procedure, or process written as source code in a conventional programming language, such as the C++ programming language, or other computer code, and may be presented for execution by the processor 112. The various implementations of the source code and object and/or byte codes may be stored in memory (not shown). The database modules 209 and 210 organize records, including map data and waypoint data, respectively, and facilitate storing and retrieving of such data to and from the processor 112. Any type of database organization may be utilized, including a flat file system, hierarchical database, relational database, distributed database, and/or the like.

Data modules 201 through 204 represent data sources for sensor data 201, vehicle operation data 202, vehicle environmental data 203, and geographic location data 204, respectively. Sensor data 201 represents data from lane position sensor 104, steering position sensor 106, or any other sensor capable of providing data that can be converted to lane variability data or from which lane variability data can be derived. Vehicle operational data module 202 represents data from ECU 108, concerning operational states of the vehicle 102. Vehicle environmental data module 203 represents data coming from one or more environmental sensors (not shown), one or more radio, cellular, satellite, or wireless data sources (not shown) from which environmental data can be received (e.g., Internet websites from which weather or traffic data can be downloaded, weather or traffic data transmissions over the AM or FM band, satellite radio weather and traffic broadcasts, and/or the like). Geographic location data module 204 comprises data from GPS receiver 110 or any other source capable of providing geographical location data for the vehicle 102.

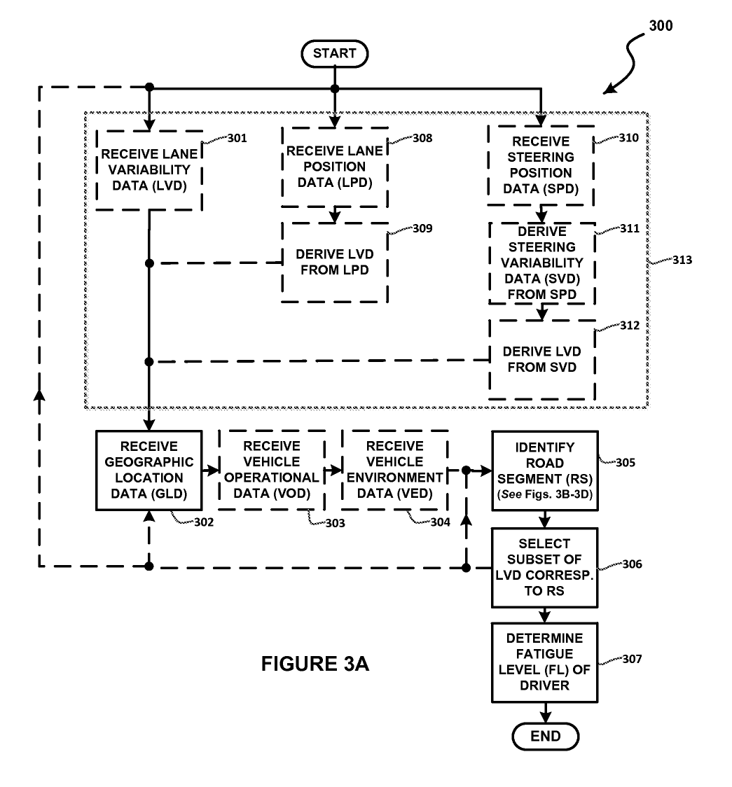

Software modules 205 through 208 represent computational functional units capable of performing specific algorithmic steps of the presently disclosed method embodiments. Lane and steering data converter module 205 is responsible for deriving lane variability data from steering position data and/or lane position data from sensors 106 and 104, in accordance with steps 308 through 312 of method 300 (FIG. 3). Geographic location data module 204 represents data from the GPS receiver 110 or another source of geographical location data. Database modules 209 and 210 comprise map data and waypoint data, respectively. Output 211 comprises output from system 200, in the form of a fatigue level of the driver 101 of the vehicle 102.

The multiple views of FIG. 3 provide flowcharts illustrating methods in which a fatigue level of a driver 101 may be determined. FIG. 3A, in particular, provides a flowchart illustrating a method 300 in which a fatigue level of a driver 101 may be determined from lane-variability data and geographic location data of the vehicle 102, in accordance with particular embodiments. Method 300 commences with a block of steps 313 forming a solitary logical/functional unit (and comprising step 301 and steps 308 through 312) designed to assure that lane variability data is received by the processor 112. Block 313 comprises three (3) alternative pathways, each one of which results in having lane variability data be received at the processor 120: i) step 301, wherein lane variability data is directly received; ii) steps 308 and 309, wherein lane position data is received a the processor and lane variability data is derived therefrom, respectively; and iii) steps 310, 311, and 312, wherein steering position data is received at the processor, steering variability data is then derived therefrom, and then variability data is derived from the derived steering variability data, respectively. According to some embodiments, as used within the following discussion and within the appended claims, the term “receiving lane variability data” may refer alternatively to receiving lane variability data directly at the processor, as in step 301, or in receiving some other type of data at the processor (e.g., lane position data, steering position data, etc.) and deriving lane variability data from the received data, as in steps 308-312 and/or the like.

Lane variability data, whether directly received in step 301 or derived in steps 309 or 312, comprises any data capable of indicating fluctuations or changes in position over time of a vehicle 120 within a driving lane. Non-limiting examples of step-301 received lane variability data, step-309 derived lane variability data, or step-312 derived lane variability data comprise variability of a distance between the center of the vehicle 120 and the center of a driving lane, variability of the distance between a wheel of the vehicle and the side of a driving lane, and/or the like.

If lane variability data is not itself available for receipt at the processor 120, method 300 may execute functional block 313 by sending process flow through step-308, where lane position data is received at processor 120 instead of lane variability data. Step-308 received lane position data comprises any data capable of determining the location of vehicle 120 in a driving lane. Non-limiting examples of step-308 received lane position data may comprise a distance between the center of the vehicle 120 and the center of a driving lane, the distance between a wheel of the vehicle 120 and the side of a driving lane, and/or the like. In some non-limiting embodiments, receiving lane position data in step 308 may comprise receiving video data from a camera mounted on the front, side, or rear of the vehicle and applying image-analysis techniques to the collected video data. In other non-limiting embodiments, a lane position sensor 104 can be configured to monitor a current lane position and/or a lane position change of the vehicle. In other non-limiting embodiments, the lane position sensor includes a magnetic sensing element configured to detect magnetic markers positioned on a roadway. In other non-limiting embodiments, the lane position sensor includes a global positioning system (GPS) with an electronic map. The lane position sensor 104 is configured to monitor a lane position of the vehicle based on the current location of the vehicle in relation to the electronic map. In some non-limiting embodiments, the lane position sensor includes a video camera and an image processor. The video camera is configured to capture a current view of the roadway in front of the vehicle. The image processor is configured to determine a lane position of the vehicle based on the images captured by the video camera. In some non-limiting embodiments, the lane position sensor may include other suitable sensing and/or processing components. In some non-limiting embodiments, the lane position sensor may be omitted, and a lane position signal may be derived based on input from the steering sensor. In at least one of the foregoing embodiments, the signal acquired by the optional lane position sensor may be processed with a high-pass filter to remove low-frequency variability associated with, for example, driving along curves. Such processing may occur along any suitable point along the signal processing chain. PCT Published Patent Application No. WO 2012/074935, the entirety of which is hereby incorporated herein by reference, for an “Alertness Monitoring System and Associated Methods,” submitted on Nov. 28, 2011 (international filing date) by Van Dongen and Forsman and published on Jun. 7, 2012, provides a non-limiting example of a lane-position sensor according to the foregoing discussion (see, e.g., optional lane-position sensor 104 of paragraph [0019]).

Deriving lane variability data from lane position data in step 309 comprises applying any technique, method, algorithm and/or the like known or yet-to-be discovered in the art that can convert step-308 received lane position data into lane variability data of the type received in step 101. Non-limiting examples of such techniques, methods, and algorithms may comprise (without limitation): calculating one or more metrics over evenly spaced time intervals. Non-limiting examples of metrics include: calculating with the lane position data or the rate of change of the lane position data the standard deviation, the variance, the skewness, the entropy, the average absolute distance, the percentage of data where the lane position is greater (or lesser) than a threshold, the Fourier transform coefficients, and/or the like. According to particular embodiments, the lane position data may also be spectrally filtered to certain frequency components before calculating any of the aforementioned metrics.

If neither lane variability data nor lane position data are available for receipt at the processor, method 100 may execute block 313 by sending process flow through Step-310, wherein steering position data is received at the processor instead. Step-310 steering position data comprises any data reflecting the position of a steering wheel of a vehicle as a function of time. Non-limiting examples of step-310 received steering position data comprise data received from a steering sensor, such as installed on an input shaft proximate a gearbox or at other suitable locations in the vehicle. In particular non-limiting embodiments, the steering sensor may include a torque sensing element and a rotation sensing element. The torque sensing element may be configured to convert a steering torque input and/or direction into electrical or optical signals. The rotation sensing element may be configured to convert rotation speed and/or direction into electrical or optical signals. The steering sensor may also include an interface circuit configured to convert the signals from the torque and rotation sensing elements into signals corresponding to a steering wheel position or change in steering wheel position of the vehicle. In other embodiments, the steering sensor may include only one of the torque and rotation sensing elements, a steering angle sensing element, and/or other suitable sensing elements. PCT Published Patent Application No. WO 2012/074935 for an “Alertness Monitoring System and Associated Methods,” submitted on Nov. 28, 2011 (international filing date) by Van Dongen and Forsman and published on Jun. 7, 2012, provides a non-limiting example of a steering sensor according to the foregoing discussion (see, e.g., steering sensor 306 of paragraph [0018]). Collecting steering data in step 104 comprises collecting steering data from the steering sensor.

Converting step-310 received steering position data into steering variability data in step 311 comprises applying any technique, method, algorithm and/or the like known (or yet-to-be discovered) in the art that can convert step-310 received steering position data into steering variability data. Non-limiting examples of such techniques, methods, and algorithms may comprise calculating one or more metrics over evenly spaced time intervals. Non-limiting examples of such metrics may comprise: calculating with the steering position data or the rate of change of the steering position data, the standard deviation, the variance, the skewness, the entropy, the average absolute rate of steering angle change, the percentage of data where the rate of change is greater (or lesser) than a threshold, the Fourier transform coefficients, and/or the like. According to particular embodiments the steering position data or steering rate data may also be spectrally filtered to certain frequency components before calculating any of the aforementioned metrics.

Further, deriving lane variability data from steering variability data in step 312 comprises applying any technique, method, algorithm and/or the like known (or yet-to-be discovered) in the art that can convert step-311 converted steering variability data into lane variability data of the type received in step 301. Non-limiting examples of such techniques, methods, and algorithms may comprise: transforming the steering variability to lane variability by using a statistical kinematic model of the vehicle based on vehicle operating parameters, and/or the like. This may include, without limitation, vehicle length, width, steering ratio, vehicle speed. The resulting model may result in a system of equations that are generated directly from such physical variables, or may comprise a black-box model (such as, without limitation, AR, MA, ARMA, neural network, and/or the like) that implicitly incorporates the physical variables based on a best-fit approach, and/or the like.

Upon completion of step 301, step 309, or step 312, step block 313 terminates and flow then proceeds to step 302, wherein geographic location data is received at the processor.

Step-302 received geographic location data comprises any data capable of indicating the geographical location of the vehicle. Non-limiting examples of step-403 received geographic location data comprise global-positioning satellite (GPS) data from a GPS device, map data such as that received from an Internet-enabled smartphone (Google maps, mapquest, and/or the like), and/or the like.

Method 300 may continue in optional step 303 wherein vehicle operational data is received at the processor. Step-303 received vehicle operational data comprises any data regarding how the vehicle is being operated by the driver. Non-limiting examples of step-303 received operational data comprise: steering data, variability of steering data, braking data, variability of braking data, speed data, variability of speed data, acceleration data, variability of acceleration data, turn signal data, variability of turn signal data, vehicle load, gas consumption, variability of gas consumption, gas mileage, variability of gas mileage, and/or the like.

Method 300 may continue in optional step 304 wherein vehicle environmental data is received at the processor. Step-304 received vehicle operational data comprises any data regarding the physical environment in which the vehicle is operated or driven. Non-limiting examples of step-304 received vehicle operational data comprise weather data, traffic data, road condition data, wind speed, and/or the like.

Method 300 continues in step 305, wherein a road segment is identified by the processor. A step-305 identified road segment comprises any specific street, road, highway, freeway, interstate highway, exit, artery, avenue, boulevard, beltway, parkway, byway, bypass, side street, alleyway, crossroad, any other specific carriageway by which a vehicle may travel during the driving of a driving route or trip, and/or the like. A driving route or trip typically comprises a plurality of road segments. Step-305 identified road segments may also (without limitation) be identified by name—e.g., Highway 202 between exits 36 and 38, Main Street between 1^{st} and 4^{th} Avenues, and/or the like. A step-305 identified segment may comprise at least in part a segment start location and a segment end location, collectively referred to herein, and in the appended claims, as “nodes.” An ordered string of segments are pieced together to form a route by use of the nodes, inasmuch as the segment end location of one segment becomes the segment start location of the following segment. The “nodes” terminology is useful when needing to refer to such locations irrespective of having to specify to which segment the node corresponds.

The act of identifying a road segment in step 305 may comprise any method of identifying a road segment as known in the art. Three non-limiting examples of a identifying a road segment in step 305 are illustrated in FIG. 3B, and respectively comprise: i) analyzing geographic position data to identify a road segment (optional step 321); ii) identifying a route segment between two waypoints (optional step 322); and iii) identifying characteristics of an RS based upon map data (optional step 323).

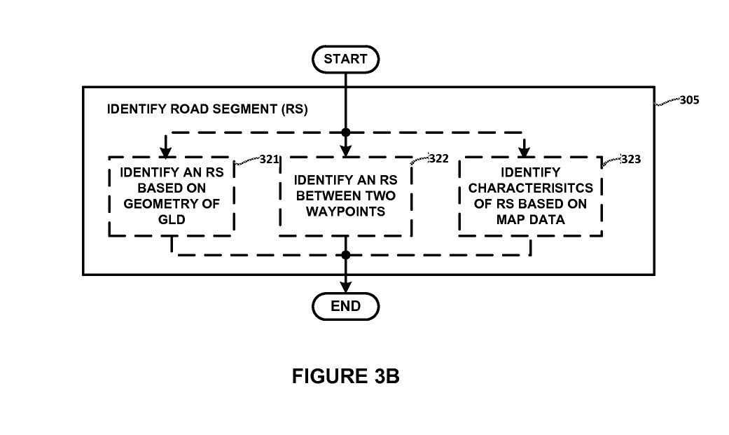

Identifying road segments based on the geometry of the geographic location data in step 321 comprises an analyzing the sequence of vehicle coordinates to identify the subsets of points that match road segment types of interest. For instance, one analysis may be to identify all one-mile long straight road segments. The coordinate data (see example of FIG. 4) can be compared with a straight line, and if the average deviation between the model line and the set of data points is within a set threshold, then the geographic location data is identified as belonging to the straight road segment. Identifying curved segments can be performed by fitting the geographic coordinates against a model equation of a curved segment, and determining if the fit is within a set tolerance. Other methods may comprise identifying shapes from data, and/or classifying spatial data, and/or the like, as are known (or yet to be discovered) in the art.

Identifying a road segment between two waypoints in step 322 may comprises using geo-fencing to determine when a vehicle enters and exits virtually defined geographic regions. These geographic zones may be determined based on a number of factors, non-limiting examples of which may comprise: frequently travelled routes, routes with high number of safety critical events, and/or the like. An example, according to particular embodiments, is a geo-fence that can be created along the I-95 corridor between two route markers, e.g., marker 53 and marker 68, also known as “waypoints.” Whenever a vehicle passes through the geo-fence, the vehicle data for the corresponding time period is identified as being associated with a road segment of interest, defined as the boundaries of the geo-fence. Waypoint identifiers may be obtained from waypoint database 210 (FIG. 2).

Identifying a road segment based upon map data in step 323 comprises a query of the road characteristics stored in a map/GIS database at the vehicle's geographic location. The map database stores information of the road characteristics (such as highway, city street, curvature, maximum speed, length, segment identifier), and based on retrieved characteristics of the location, a road segment can be dynamically be identified. For example, a curved road segments can be identified as the sequential period where the road information returned at geographic location data is all same type (i.e. highway type) and of the same fixed curvature, and if the distance traversed sums to one mile. Map data may be obtained from data database 209 (FIG. 2).

Method 300 continues in step 306, wherein a subset of the step-301 received lane variability data is selected based upon the step-305 identified road segment. A non-limiting example of a method 306 is first to identify the time interval the vehicle is traversing along the road segment of interest by finding the points at which the distance between the vehicle as recorded in geographic location data and the identified road segment is within a set criteria. Once the time interval of when the vehicle traverses the road segment is identified, the subset of lane variability data is created by selected the data with timestamps that fall within the identified interval of interest.

Method 300 then continues to step 307, wherein a fatigue level for a driver of the vehicle is determined. A step-307 determined fatigue level comprises any metric, value, function, indicator, classifier, or other means of indicating the fatigue of a driver. For one such embodiment, the determined step-307 fatigue level (“fatigue level” hereinafter) is a linear combination of the lane variability data, weighted by a weighting vector a.

F=αLV (1)

In embodiments where environmental and/or operational data are included, then the fatigue level can be a linear combination of all the lane variability, along with the operational data and/or environmental data, of the general forms:

F=(αLV+/βVOD+γVED) (2a)

F=(αLV+βVOD) (2b)

F=(αLV+γVED) (2c)

According to particular embodiments, the weighting vector could be a function of the operational and environmental data, which for instance would allow for more lane variability under certain circumstances (e.g., wind, snow, heavy traffic, etc.) without assessing the driver as more fatigued:

F=α(VOD,VED)−LV (3)

For such embodiments, it may be necessary to convert the step-304 received vehicle environmental data into a numeric format suitable for the foregoing equations or their equivalents. Such conversions could take the form of: representing snowy conditions numerically (e.g., 1=snow, 0=no snow; or a snow scale score 0=no snow to 10=blizzard, and/or the like), representing windy conditions numerically (e.g., wind speed, wind speed categories, and/or the like), representing traffic conditions numerically (e.g., 0=no traffic; traffic classifier scale up to 10 indicating stand-still traffic, and/or the like), and representing road condition in a numeric fashion (e.g., a scale indicating difficulty of smooth vehicle passage, and/or the like). Conversely, step-303 received vehicle operational data may need to be converted into numeric form for those occasional situations where it is not already so formatted (e.g., turn-signal data could be expressed as the number of times a turn signal is activated per fixed unit of time, such as 15 min intervals, and/or the like.)

According to particular embodiments, the determined fatigue level can also be a non-linear combination the lane variability, vehicle operational data, and vehicle environmental data, thusly:

F=f(LV,VOD,VED) (4)

The weighting vectors (or nonlinear function) can additionally, in particular embodiments, be dependent on the road type, which would allow for instance more lane variability in difficult (or curvy) road segments without assessing the driver as more fatigued.

F=α_{RCT}(VOD,VED)·LV (5)

Or, in particular embodiments, a nonlinear version may be used:

F=f_{RCT}(LV,VOD,VED) (6)

where f_{RCT} represents a function whose form depends upon the road classification type.

According to particular embodiments, instead of a fatigue level, a fatigue state may be of interest (e.g. Fatigued vs Alert) and this case the fatigue level may be classified as “fatigued” using any number of classification schemes known in the art. In one embodiment a linear classifier maybe used based on a simple threshold, T.

F_{class}=F>T (7)

where F_{class} represents the fatigue level of the driver 101 as a binary classification variable (1=fatigued; 0=not fatigued).

In alternative embodiments, a step-307 determined fatigue level may be determined using two or more road segments for which lane variability data is selected over a course of trip (i.e. the driver traverses many road segments during the entire duration of the drive), and an overall fatigue level may be assessed by linearly or nonlinearly combining the assessed fatigue levels for up to all (without limitation) of the road segments traversed during the trip. For one such embodiment, the trip fatigue level is a linear combination of the fatigue levels Fᵢ, where i is an index used to track the segments traversed during the trip.

$${F}_{trip} = {\sum }_{i}^{ } {w}_{i} {F}_{i} \qquad ( 8 )$$

And where wᵢ is the weighting factor for each segment of the trip. In the simplest combination the weighting would be the same for all segments, and equal to the inverse of the total number of road segments traversed during the overall trip. An average can also be used, according to particular embodiments, which may take a form similar to:

$${F}_{trip} = \frac{1}{N} {\sum }_{i}^{ } {w}_{i} {F}_{i} \qquad ( 9 )$$

where N represents the number of road segments used to determine the trip fatigue level.

FIG. 4 illustrates how GPS data may be analyzed to determine a road shape driving criterion. GPS data reflecting the vehicle's longitude and latitude is plotted using a parametric time variable—i.e., the vehicle's position as a function of time may be expressed as (x(t),y(t))=(latitude(t), longitude (t)). This parametric plot may then be analyzed for curved road sections and for straight road sections—appropriately labeled in FIG. 4.

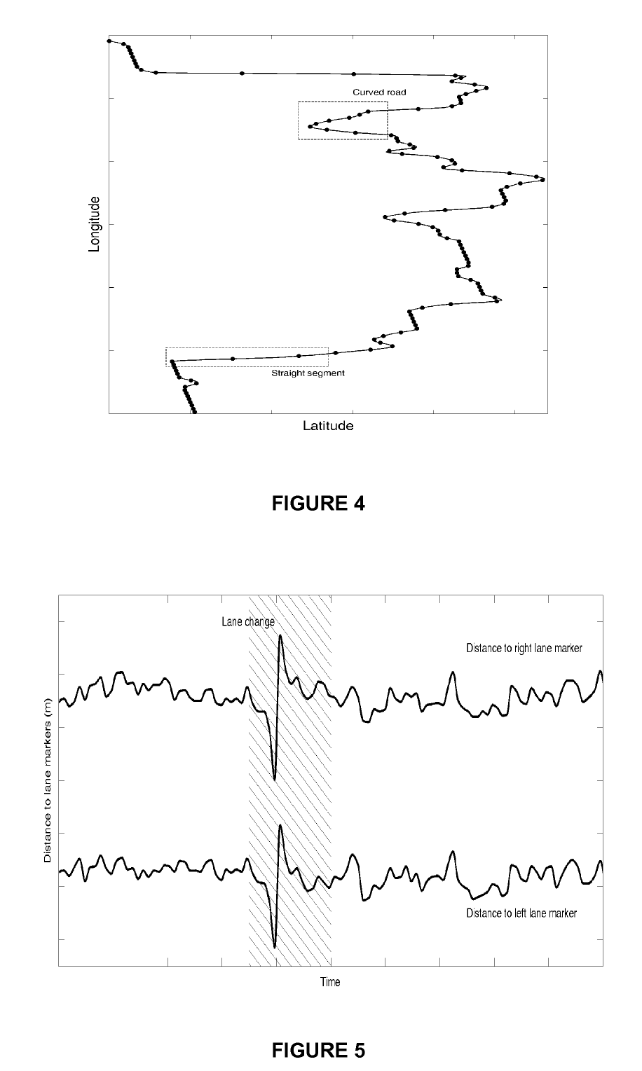

FIG. 5 provides a plot illustrating how lane position data may be analyzed to determine the existence of a lane-change driving criterion. FIG. 5 comprises two plots illustrating the distance (as a function of time) from a point on the vehicle (e.g., center of the vehicle) to each of the right lane marker and left lane marker, respectively. The shaded region in FIG. 5 illustrates a the characteristic features of a lane change maneuver by the vehicle—in as much as the distance from a lane marker transitions quickly from a minimum value to a maximum value as the vehicle crosses the lane marker dividing line. Lane position data can be analyzed to determine the existence of such characteristics and, therefore, the existence of lane changes.

What is claimed is:

1. A method, using a processor, for determining a fatigue level of a driver of a vehicle based at least in part upon lane variability data and geographic location data for the vehicle, the method comprising:
receiving, at the processor, lane variability data, the lane variability data corresponding to a change of position of a vehicle in a driving lane;
receiving, at the processor, geographical position data for the vehicle;
identifying, with the processor, a road segment of interest based at least in part on the received geographical data;
selecting, with the processor, a subset of the received lane variability data corresponding to the vehicle travelling over the identified road segment of interest; and
determining, with the processor, a fatigue level, F, of a driver of the vehicle based at least in part upon the selected subset of the received lane variability data.

2. The method of claim 1 wherein the determined fatigue level, F, of a driver of the vehicle is of the form:
F=αLV
where LV represents the lane variability of the vehicle as it travels the road segment of interest and is determined from the selected subset of the received lane variability data, and where a represents a proportionality constant.

3. The method of claim 1 wherein the determined fatigue level, F, of a driver of the vehicle comprises a nonlinear function of the selected subset of the received lane variability data.

4. A method according to claim 1 wherein receiving lane variability data comprises:
receiving, at the processor, lane position data from a lane position sensor affixed to the vehicle; and
deriving, at the processor, lane variability data based upon the received lane position data.

5. A method according to claim 1 wherein receiving lane variability data comprises:
receiving, at the processor, steering position data from a steering sensor affixed to a steering apparatus of the vehicle; and
deriving, at the processor, lane variability data based upon the received steering position data.

6. A method according to claim 5 wherein deriving lane variability data based upon the received steering position data comprises:
deriving, with the processor, steering variability data based upon the received steering position data; and
applying a transfer function, with the processor, to the derived steering variability data to determine lane variability data.

7. A method according to claim 1 wherein receiving the geographical position data for the vehicle comprises receiving GPS data from a GPS device associated with the vehicle.

8. A method according to claim 1 wherein identifying a road segment of interest comprises at least in part determining road geometry by analyzing at least the received geographical location data.

9. A method according to claim 8 wherein determining road geometry comprises identifying a road classification type comprising one or one or more of: a straight road portion, a curved road portion with a constant radius of curvature, a curved road portion with a variable radius of curvature, a curved road portion with both a positive and a negative radius of curvature, an uphill road segment, a downhill road segment, and a road segment with both uphill and downhill portions.

10. A method according to claim 1 wherein identifying a road segment of interest comprises:
receiving one or more waypoint locations, each waypoint location representing the location of point of travel for the vehicle; and
wherein identifying, with the processor, a road segment of interest is further based on comparing the received one or more waypoint locations to the received geographical position data.

11. A method according to claim 10 wherein the received one or more waypoint locations correspond to one of a start road segment waypoint, and an end road segment waypoint.

12. A method according to claim 1 wherein identifying a road segment of interest comprises at least in part: identifying, with the processor, characteristics of the road based at least in part on map data corresponding to the received geographical position data.

13. A method according to claim 9 wherein determining a fatigue level of the driver further comprises determining a fatigue level of the driver based at least in part upon the road type classification.

14. A method according to claim 13 wherein the determined fatigue level, F, of a driver of the vehicle is of the form:
F=α_{RCT}LV
where LV represents the lane variability of the vehicle as it travels the road segment of interest and is determined from the selected subset of the received lane variability data, and α_{RCT} represents a proportionality constant determined at least in part upon the road classification type.

15. A method according to claim 1 further comprising:
receiving, at the processor, vehicle operational data corresponding to one or more operational states of the vehicle, and
wherein determining, with the processor, a fatigue level, F, of a driver of the vehicle is further based at least in part upon the received vehicle operational data.

16. A method according to claim 15 wherein the determined fatigue level, F, of a driver of the vehicle is of the form:
F=αLV+βVOD
where LV represents the lane variability of the vehicle and is determined from the selected subset of the received lane variability data, VOD represents the vehicle operational data, and α and β represent proportionality constants.

17. A method according to claim 15 wherein the determined fatigue level, F, of a driver of the vehicle comprises a nonlinear combination of the selected subset of the received lane variability data and the received vehicle operational data.

18. A method according to claim 15 wherein the received vehicle operational data comprises one or more of: steering data, variability of steering data, braking data, variability of braking data, speed data, variability of speed data, acceleration data, variability of acceleration data, turn signal data, variability of turn signal data, vehicle load, gas consumption, variability of gas consumption, gas mileage, and variability of gas mileage.

19. A method according to claim 15 wherein identifying a road segment of interest further comprises identifying a road segment of interest based upon the received vehicle operational data.

20. A method according to claim 15 wherein determining a fatigue level, F, of a driver of the vehicle is further based at least in part upon the received vehicle operational data.

21. A method according to claim 1 further comprising:
receiving, at the processor, vehicle environmental data corresponding to one or more environmental states of the vehicle, and
wherein determining, with the processor, a fatigue level, F, of a driver of the vehicle is further based at least in part upon the received vehicle environmental data.

22. A method according to claim 21 wherein the determined fatigue level, F, of a driver of the vehicle is of the form:
F=αLV+γVED
where LV represents the lane variability of the vehicle and is determined from the selected subset of the received lane variability data, VED represents the received vehicle environmental data, and α and γ represent proportionality constants.

23. A method according to claim 21 wherein the received vehicle environmental data comprises one or more of: weather data, traffic data, road condition data, and wind speed.

24. A method according to claim 21 wherein identifying a road segment of interest further comprises identifying a road segment of interest based upon the received vehicle environmental data.

25. A method according to claim 21 wherein determining a fatigue level of a driver of the vehicle is further based at least in part upon the received vehicle environmental data.

26. A method according to claim 1 further comprising:
repeating two or more times the steps of:
identifying, with the processor, a road segment of interest based at least in part on the received geographical data; and
selecting, with the processor, a subset of the received lane variability data corresponding only to lane position data corresponding to the identified road segment of interest; and
wherein determining a fatigue level, F, of a driver of the vehicle is based at least in part upon two or more of the selected subsets of the received lane variability data

27. A method according to claim 26 wherein determining a fatigue level, F, of a driver of the vehicle comprises:
determining, with the processor, a segment fatigue level, Fᵢ, of a driver of the vehicle for each of the selected subsets of the received lane variability data,
determining, the fatigue level, F, based at least in part on a function of each of the determined segment fatigue levels, Fᵢ.

28. A method according to claim 27 wherein the function of each of the determined segment fatigue levels, Fᵢ, is a weighted average function, such that
$$F = \frac{1}{N} {\sum }_{i}^{N} {ω}_{i} {F}_{i}$$
where Fᵢ represents the determined fatigue level of the driver of the vehicle for the identified road segments of interest based at least in part upon the selected subset of the received lane variability data, where F represents the fatigue level of the driver of the vehicle over all selected subsets of lane variability data, where ωᵢ represents a set of weights, where N represents the number of repetitions of the steps of identifying a road segment and selecting a subset of lane variability data, and where i represents an index variable whose values, ranging from 1 to N, correspond to each of the at least two repetitions.

29. A method according to claim 26 further comprising:
receiving, at the processor, vehicle operational data corresponding to one or more operational states of the vehicle; and
wherein for at least one repetition of the steps of identifying a road segment and selecting a subset of the lane variability data, the determined fatigue level, F, of a driver of the vehicle is of the form:
F=αLV+βVOD
where LV represents the lane variability of the vehicle and is determined from the selected subset of the received lane variability data, VOD represents the vehicle operational data, and α and β represent proportionality constants.

30. A method according to claim 26 further comprising:
receiving, at the processor, vehicle environmental data corresponding to one or more environmental states of the vehicle; and
wherein for at least one repetition of the steps of identifying a road segment and selecting a subset of the lane variability data, the determined fatigue level, F, of a driver of the vehicle is of the form:
F=αLV+γVED
where LV represents the lane variability of the vehicle and is determined from the selected subset of the received lane variability data, VED represents the received vehicle environmental data, and α and γ represent proportionality constants.

31. A computer program product embodied in a non-transitory medium and comprising computer-readable instructions that when executed by a suitable computer cause the computer to perform a method for determining a fatigue level of a driver of a vehicle based at least in part upon lane variability data and geographic location data for the vehicle, the method comprising:
receiving, at the processor, lane variability data, the lane variability data corresponding to a change of position of a vehicle in a driving lane;
receiving, at the processor, geographical position data for the vehicle;
identifying, with the processor, a road segment of interest based at least in part on the received geographical data;
selecting, with the processor, a subset of the received lane variability data corresponding to the vehicle travelling over the identified road segment of interest; and
determining, with the processor, a fatigue level, F, of a driver of the vehicle based at least in part upon the selected subset of the received lane variability data.
